(19) United States
(12) Patent Application Publication
(10) Pub. No.: US 2018/0189799 A1
(43) Pub. Date: Jul. 5, 2018

(54) SCHEDULING EXPIRATION OF PROGRAM ASSETS

(71) Applicant: Marketo, Inc., San Mateo, CA (US)

(72) Inventors: Frank Passantino, San Mateo, CA (US); Dante Guarin, San Mateo, CA (US)

(21) Appl. No.: 15/395,431

(22) Filed: Dec. 30, 2016

(51) Int. Cl. G06Q 30/02; G06Q 10/06; G06F 9/48

(52) U.S. Cl. CPC G06Q 30/02; G06F 9/4887; G06Q 10/06316

(57) ABSTRACT

A method and system for scheduling expiration of program assets are described. The program asset expiration system receives user input corresponding to a request to set an expiration time for assets in a program and a redirect page for the assets. Upon determining that the expiration time has been reached, the program asset expiration system configures a web server to redirect requests for the expired assets to the redirect page. Received requests for program assets that are not among the assets set to expire are not redirected to the redirect page.

### TECHNICAL FIELD

Examples described herein relate to software as a service automation, and more specifically, to a system and method for scheduling expiration of program assets.

### BACKGROUND

Marketing automation is a category of technology that allows companies to streamline, automate, and measure marketing tasks and workflows so they can increase operational efficiency and grow revenue faster. Marketing automation helps marketers streamline their lead generation, segmentation, lead nurturing and lead scoring, customer lifecycle marketing, cross-sell and up-sell, customer retention, and marketing return on investment measurement. It allows marketers to integrate marketing initiatives and keep track of leads as they progress through the marketing funnel.

### BRIEF DESCRIPTION OF THE DRAWINGS

FIG. 1 illustrates an example automation management system that manages scheduling expiration of program assets, in accordance with some aspects.

FIG. 2 illustrates example program assets that can be set to expire or left active in an example program, in accordance with some aspects.

FIG. 3 describes an example method of scheduling expiration of program assets, in accordance with some aspects.

FIG. 4 illustrates a sample interface for scheduling expiration of program assets, in accordance with some aspects.

FIG. 5 illustrates a sample interface for managing a program, in accordance with some aspects.

FIG. 6 illustrates example computer systems for an automation management system in communication with other networked systems.

FIG. 7 illustrates a computer system upon which aspects described herein may be implemented.

### DETAILED DESCRIPTION

According to examples, an automation management system is provided for enabling program organizers to schedule when specified program assets, such as landing pages and program scripts as part of a marketing campaign, are no longer live. After the scheduled expiration date, visitors to expired landing pages are redirected to a web page of the program organizer's choosing, and expired program scripts no longer execute.

If marketing program assets are not manually un-published or deactivated after their useful lifetime, visitors can still visit landing pages, fill out forms, attempt to register for events, etc. for programs that occurred in the past and are no longer active. For example, live events and online seminars occur on a given date and time, but the web pages that allow visitors to register for these programs can remain active even after the date of the event is passed. Visitors can follow links from emails and the web to live landing pages for these old events, which can lead to confusion and a bad visitor experience overall.

Conventional approaches require program organizers to manually un-publish landing pages and program scripts for their programs. However, a large marketing department may concurrently run more marketing programs than its program organizers can feasibly keep track of, which can lead to outdated program assets falling through the cracks and remaining live.

A program asset expiration system provides the benefit of streamlines the process of disabling old campaign landing pages and program scripts. Furthermore, it ensures that visitors do not sign up or fill out forms for expired events with campaigns that were left live by mistake or neglect.

Conventional approaches can also support a fallback page that is used as a default for all disabled or unavailable landing pages. However, a single default page is far from ideal. The program asset expiration system provides custom fallback pages set for each program that are more appropriate than a default redirect for an entire campaign or site.

In one aspect, the program asset expiration system receives user input corresponding to a request to set an expiration time for assets in a program and a redirect page for the assets. Upon determining that the expiration time has been reached, the program asset expiration system configures a web server to redirect requests for the expired assets to the redirect page. Received requests for program assets that are not among the assets set to expire are not redirected to the redirect page.

One or more aspects described herein provide that methods, techniques and actions performed by a computing device are performed programmatically, or as a computer-implemented method. Programmatically means through the use of code, or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Furthermore, one or more aspects described herein may be implemented through the use of instructions that are executable by one or more processors. These instructions may be carried on a computer-readable medium. Machines shown or described with figures below provide examples of processing resources and computer-readable media on which instructions for implementing some aspects can be carried and/or executed. In particular, the numerous machines shown in some examples include processor(s) and various forms of memory for holding data and instructions. Examples of computer-readable media include permanent memory storage devices, such as hard drives on personal computers or servers. Other examples of computer storage media include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

System Overview

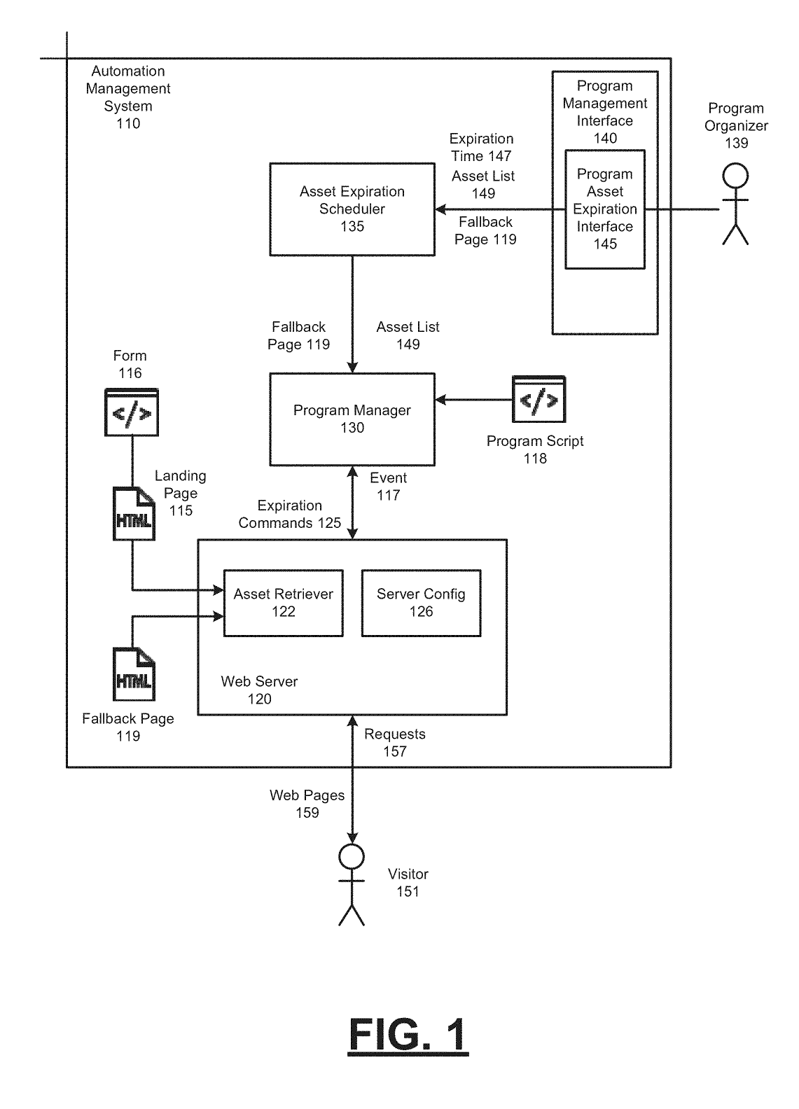

FIG. 1 illustrates an example automation management system that manages scheduling expiration of program assets, in accordance with some aspects. The automation management system 110 allows program organizers 139 to schedule when specified assets in a marketing program, such as landing pages 115 and program scripts 118 are no longer live. After the scheduled expiration date, visitors 151 attempting to access expired landing pages 115 through web server 120 are redirected to a specified fallback page 119, and expired program scripts 118 no longer execute. In some aspects, the automation management system 110 includes a web server 120, program manager 130, asset expiration scheduler 135, program management interface 140, and a program asset expiration interface 145. In addition, an example automation management system 110 can include other components and functionality not illustrated for the sake of simplicity.

In some aspects, the automation management system 110 represents a software platform implementing technologies for marketing departments and organizations to more effectively market on multiple channels online (such as email, social media, websites, etc.) and automate repetitive tasks. Marketing departments, consultants, and employees benefit by specifying criteria and outcomes for tasks and processes that are interpreted, stored, and executed by software, which increases efficiency and reduces human error. Marketing automation refers to a broad range of automation and analytical tools for marketing that can be used as a hosted or web-based solution. As a result, the automation management system 110 does not require any software installation. Instead, users such as program organizers 139 can access the automation management system 110 over a network through web-based interfaces such as the program management interface 140.

The automation management system 110 is a platform that marketers use to plan, coordinate, manage, and measure all of their marketing initiatives, both online and offline. As used herein, a program represents a single one of these marketing initiatives. In some implementations, programs act as organizational containers filled with two main types of assets that enable the program to work: customizable content (emails, web pages, forms, images, etc.) and campaigns—the automated marketing logic that tells the program what to do. As illustrated in FIG. 1, the landing page 115 is an example of the first type of asset, customizable content. The program script 118 is an example of the second type of asset, automated marketing logic, also referred to as a campaign.

A program is the mechanism by which a marketer organizes all their different types of marketing efforts from one central location. One example of a program is an email blast. A lead (e.g., visitor 151) takes multiple actions/activities related to a given program that the program manager 130 can associate with the program. This is known as lead progression. An example progression of an email blast program would record when a lead is sent an email, when the lead opens the email, and whether they clicked through a link in the email. Besides email programs, the automation management system 110 supports programs such as event programs and engagement programs. Event programs help coordinate, facilitate, and track live and online events, that is, anything that has attendees at a specific date and time. Program organizers 139 can build events utilizing a program-level calendar through the program management interface 140, sync with mobile applications, and integrate with third party event platforms. Engagement programs utilize drip nurturing strategies to engage leads, communicate with leads on a periodic schedule, and send out content based on priority and availability. Programs can also be used to build out initiatives focused on list purchases, online advertising, social media, web promotions, etc.

Campaigns are created to serve a specific purpose and specific goal within a program. An example of a campaign is a script to narrow down a group of leads and send them an email blast, or to notify a sales representative for follow up if a lead clicks through a link within the email blast program. The first is an example of a filter campaign, which searches for leads based on specific attributes and can be scheduled to run at specific dates and times. The second is an example of a trigger campaign that listens for lead behavior and fires when events occur. Both of these types of campaigns are examples of smart campaigns that a program organizer 139 can create through the program management interface 140.

In some aspects, the automation management system 110 includes a web server 120 that receives requests 157 for web pages 159 from a visitor 151. Examples are given in the context of web-based programs that utilize the web server 120, but the automation management system 110 can also schedule expiration for program assets associated with other types of programs, such as email programs. The primary function of the web server 120 is to store, process, and deliver web pages 159 to clients, such as a web browser on a computing device belonging to the visitor 151. The communication between the user computing device and web server 120 can take place using the Hypertext Transfer Protocol (HTTP). Pages delivered include Hypertext Markup Language (HTML) documents such as landing page 115, which may contain images, style sheets, and scripts in addition to text content.

In the context of an automation management system 110, visitor 151 can represent a lead. Leads are people or companies who may have an interest in a firm's products or services. Marketing departments receive new leads through marketing activities such as website visits, online or traditional advertisements, webinars, and other marketing campaigns. Depending on the reach of these marketing campaigns, millions of leads may be generated through different marketing channels.

Management of the large quantity of leads includes tracking the leads, identifying high-quality leads to pass on to sales departments, and identifying potential customers to nurture, among other examples. Management of leads can be extremely time-consuming and difficult due to the sheer volume of leads, subjective valuations of each lead, and the fact that only a small number of the leads represent people or companies with a genuine intent to purchase. Furthermore, the lifecycle of a successful lead that generates a sale, and ultimately revenue, spans across both the marketing and sales departments. As a result, efficient management of leads over their lifecycle is also important to the sales department.

An automation management system 110 helps a marketer manage a large quantity of leads. In some examples, a lead goes through a sequence of stages before resulting in a purchase. From a firm's perspective, a lead first makes itself known to the firm. Marketing staff may send emails, make phone calls, invite leads to webinars or road shows, and conduct other various marketing activities to engage and nurture the lead to a point where they are ready to make a purchase within a short period of time. The lead is then transitioned to the sales department. Sales representatives contact the lead to determine whether there is a genuine intent to purchase. If so, the lead is transitioned to a sales accepted opportunity stage. When a purchase or sale is completed, the lead transitions to a customer stage.

The sequence of stages that leads go through forms the revenue cycle of a firm. Marketing and sales departments segment leads based on stages in the revenue cycle so that leads in different stages are able to receive different levels of attention and treatment. The revenue cycle concept grows out of sales cycle and marketing cycle concepts and is adopted by firms that seek to streamline activities and management in marketing and sales departments for superior revenue generations. Existing types of revenue cycle concepts in marketing/sales practices simply combine the marketing and sales cycles.

Even a medium-sized company could get millions of leads through different marketing channels. The management of this large body of leads—to keep track of them, to identify the potential customers to nurture, to identify the high-quality ones as opportunities, among other activities—is extremely time-consuming and difficult. To keep track of all the interactions and associations between them and the opportunities is even more challenging. Marketing activities associated with the leads include marketing actions as well as actions taken by sales staff—i.e., sales emails, phone calls, online meeting, demos, customer visits, etc. They also include activities originated by the leads themselves, such as web site visits and form fill-outs, both before and after the leads reach the opportunity stage.

In some aspects, forms that leads fill out, details recorded during phone calls, and online interactions are provided to the automation management system 110. For example, a visitor 151 can fill out a form 116 and submit the form 116 back to the web server 120. In other aspects, data are first entered into other databases such as customer relationship management (CRM) systems and then imported into the automation management system 110 through one or more interfaces (not illustrated).

In one example, the program organizer 139 accesses the program management interface 140 to create an event program for a dinner event. The program organizer 139 can set various parameters and program settings for the program, including a date and time for the dinner and a description. The program organizer 139 would like to allow people to RSVP for the dinner so they create a form 116 through the program management interface 140 that requests a name and contact details for anyone wishing to attend. The program organizer 139 then creates a landing page 115 through the program management interface 140 for the dinner. The program organizer 139 can generate the landing page 115 using a template system that the program management interface 140 provides and can include further details regarding the dinner for visitors 151 to read. With the landing page 115 created, the program organizer 139 can insert the form 116 into the landing page 115 so that visitors 151 to the landing page 115 can fill out the form 116 to RSVP to the dinner. The program organizer 139 can then distribute a link to the landing page 115, for example through emails, a link on another web page, or social media postings.

Thus, when a visitor 151 follows the link to the landing page 115, their web browser contacts the web server 120 with a request 157. The web server 120 can include an asset retriever 122 component to fetch the landing page 115, which includes form 116. The web server 120 can then provide these program assets to the visitor 151. If the visitor 151 fills out the form 116 to register for the dinner, code embedded in the landing page 115 associated with the form 116 can trigger the creation of an event 117 on an activity log for the visitor 151 called ‘filled out form’ with the URL in the activity details. The program manager 130 actively listens for this event 117 to occur on the activity log, at which point a series of actions are performed as defined in the trigger campaign (i.e., program script 118). For example, the program script 118 can contain instructions to the program manager 130 to add the visitor 151 to a guest list, send them an email confirmation, and redirect their web browser to a ‘thank you’ page, among other actions.

However, after the time for the dinner has passed, the landing page 115, form 116, and program script 118 remain active. As a result, visitors 151 can still follow old links from emails and social media postings to the landing page 115 and fill out the form 116 to register for the dinner, despite the fact that the dinner was already held. This can result in confusion and a bad user experience in general. Rather than require program organizers 139 to manually deactivate their outdated programs and program assets when they are no longer needed, the program management interface 140 can provide a program asset expiration interface 145 to streamline the process of disabling old program landing pages 115 and trigger campaigns. This ensures that visitors 151 do not sign up or fill out forms 116 for expired events with campaigns that were left live by mistake or neglect.

In some aspects, program organizers 139 can use the program asset expiration interface 145 to go through a list of marketing program assets and deactivate, or schedule a later deactivation for, specific assets such as landing pages 115 and trigger campaigns (e.g., program script 118). The program organizer 139 can choose a date/time for the program to expire (expiration time 147), choose which assets expire (asset list 149), and set a redirect page to send visitors to when they access an expired landing page 115 for that program (fallback page 119). Rather than deactivating an entire program, program assets that are not time-sensitive such as presentation materials available to attendees can be left active indefinitely.

In one aspect, the program asset expiration interface 145 provides the asset expiration settings to an asset expiration scheduler 135, which is a time-based job scheduler within the automation management system 110. When the asset expiration scheduler 135 determines that the expiration time 147 for one of the assets on the asset list 149 has been reached, the 135 can provide the asset's details and a fallback page 119 link to the program manager 130.

If the expired asset is a trigger campaign such as program script 118, program manager 130 can deregister any event listeners for the program script 118, thereby deactivating the trigger campaign. As a result, when future visitors 151 submit form 116, the program script 118 will no longer be listening for event 117 and program script 118 will not execute. In some implementations, the program manager 130 can provide an error message or other indication that the program script 118 is expired to the visitor 151.

If the expired asset is a landing page 115 or other web-based asset, the program manager 130 sends a set of expiration commands 125 to the web server 120 to update the server configuration 126 so that future requests 157 for the landing page 115 are redirected to a custom fallback page 119 for that program asset. Custom fallback pages 119 set for each asset can redirect visitors 151 to more appropriate web pages 159 than a default redirect for an entire program or website.

In one implementation, the server configuration 126 is updated to perform an HTTP redirect from the landing page 115 link to the fallback page 119 link. The server configuration 126 can include an httpd.conf or .htaccess file, among other configuration methods. HTTP redirection, or URL redirection, is a technique of pointing one domain or address to another. Redirects are used whenever a site needs people requesting one address to be directed to another address. When a web browser attempts to open a URL that has been redirected, a page with a different URL is opened instead. In one example, the expired landing page 115 can return an HTTP status code 301 signifying a permanent redirect to the fallback page 119. In another example, the web server 120 can use a rule-based rewriting engine to rewrite requests for the landing page 115 to point to the fallback page 119. In other implementations, the web server 120 can redirect requests 157 using aliases, symbolic links, or by adding scripts to the landing page 115 itself to instruct a web browser to open the fallback page 119.

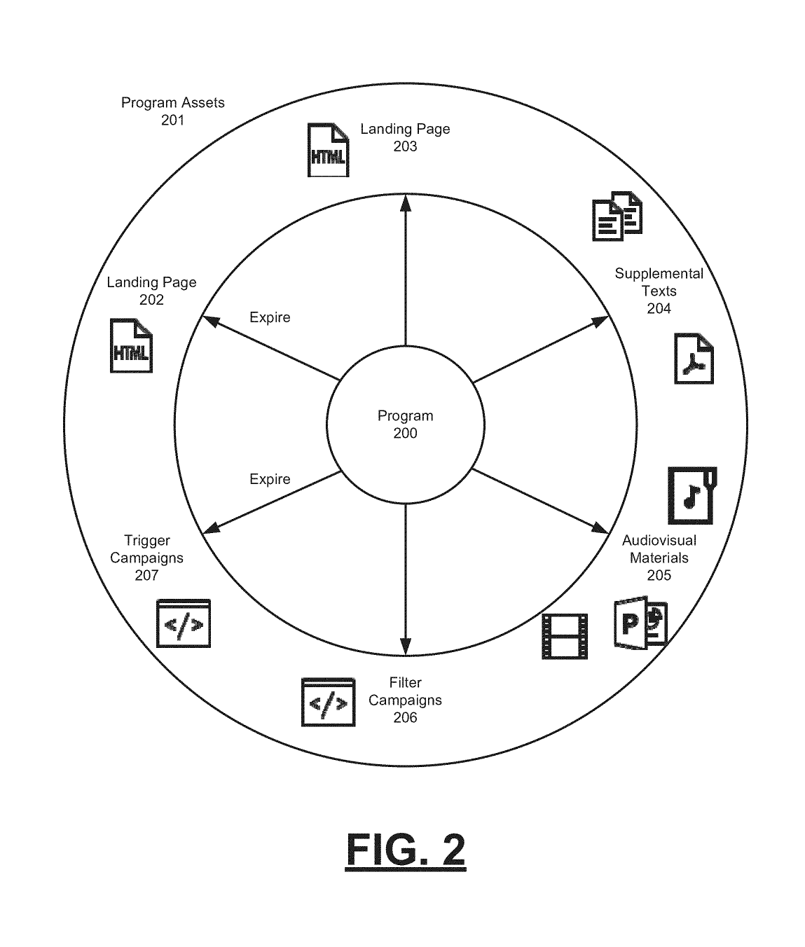

FIG. 2 illustrates example program assets that can be set to expire or left active in an example program, in accordance with some aspects. Program organizers can use an automation management system to go through a list of marketing program assets 201 and deactivate, or schedule a later deactivation for, specific assets such as landing pages 202 and trigger campaigns 207. The program organizer can choose a date/time for the program assets 201 to expire, choose which assets expire, and set a redirect page to send visitors to when they access an expired landing page 202 for that program 200.

The automation management system 110 is a platform that marketers use to plan, coordinate, manage, and measure all of their marketing initiatives, both online and offline. As used herein, a program 200 represents a single one of these marketing initiatives. In some implementations, programs 200 act as organizational containers filled with two main types of assets that enable the program to work: customizable content (emails, web pages, forms, social assets, etc.) and campaigns—the automated marketing logic that tells the program what to do. Further examples of program assets include email templates, landing pages, landing page templates, snippets, forms, tokens, and files.

Campaigns are created to serve a specific purpose and specific goal within a program 200. An example of a campaign is a script to narrow down a group of leads and send them an email blast, or to notify a sales rep for follow up if a lead clicks through a link within the email blast program. The first is an example of a filter campaign 206, which searches for leads based on specific attributes and can be scheduled to run at specific dates and times. The second is an example of a trigger campaign 207 that listens for lead behavior and fires when events occur. Both of these types of campaigns are examples of smart campaigns.

In some aspects, specific program assets 201 that should be expired are landing pages 202 and trigger campaigns 207. Other program assets such as presentation materials available to attendees can be left active indefinitely. For example, a program organizer can create a program 200 for a live event that includes a presentation given to the audience. The program organizer can create a landing page 202 advertising the event that includes an RSVP form and send a link to the landing page 202 through email, social media, etc. to prospective attendees. Attendees can then register for the event online using the form on the landing page 202, which trigger campaign 207 listens to.

However, even after the live event and presentation are over, the landing page 202 with its form and associated trigger campaign 207 remain active. As a result, visitors can still follow old links from emails and social media postings to the landing page 202 and fill out the form to register for the event, despite the fact that it was already held. This can result in confusion and a bad user experience in general. Rather than require program organizers to manually deactivate their outdated programs 200 and program assets 201 when they are no longer needed, the automation management system can streamline the process of disabling these assets. This ensures that visitors do not sign up or fill out forms for expired events with campaigns that were left live by mistake or neglect.

In some aspects, program organizers can schedule a deactivation time for specific assets such as landing pages 202 and trigger campaigns 207. Rather than deactivating an entire program 200, program assets 201 that are not time-sensitive can be left active indefinitely. For example, a secondary landing page 203, supplemental texts 204, and audiovisual materials 205 related to the presentation can remain online and accessible even after the presentation. The old landing page 202 can be set to redirect future visitors to a fallback page, while another landing page 203 remains live and informs visitors that the event is over and provides links to the presentation materials.

Methodology

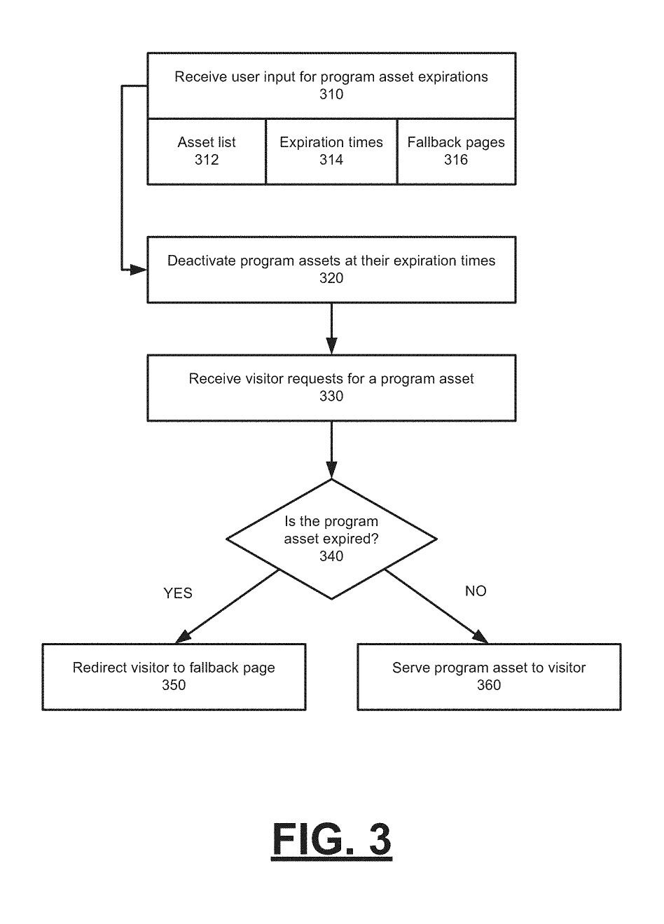

FIG. 3 describes an example method of scheduling expiration of program assets, in accordance with some aspects. While operations of the method are described below as being performed by specific components, modules or systems of automation management system 110, it will be appreciated that these operations need not necessarily be performed by the specific components identified, and could be performed by a variety of components and modules, potentially distributed over a number of machines. Accordingly, references may be made to elements of automation management system 110 for the purpose of illustrating suitable components or elements for performing a step or sub step being described. Alternatively, at least certain ones of the variety of components and modules described in automation management system 110 can be arranged within a single hardware, software, or firmware component. It will also be appreciated that some of the steps of this method may be performed in parallel or in a different order than illustrated.

In some aspects, program organizers 139 can use a program asset expiration interface 145 to provide user input to deactivate, or schedule a later deactivation for, specific program assets such as landing pages 115 and trigger campaigns (310). The program organizer 139 can choose a date/time for the program to expire (expiration times 314), choose which assets expire (asset list 312), and set a redirect page to send visitors to when they access an expired landing page 115 for that program (fallback pages 316).

In one aspect, the program asset expiration interface 145 provides the asset expiration settings to an asset expiration scheduler 135, which is a time-based job scheduler within the automation management system 110. When the asset expiration scheduler 135 determines that the expiration time 147 for one of the assets on the asset list 149 has been reached, the 135 can provide the asset's details and a fallback page 119 link to the program manager 130 to deactivate the program assets (320).

The web server 120 can receive visitor requests for program assets such as the landing page 115 or other web content (330). Depending on whether the program asset has expired, the visitor 151 may be redirected (340). For example, if the expired asset is a landing page 115 or other web-based asset, the program manager 130 sends a set of expiration commands 125 to the web server 120 to update the server configuration 126 so that future requests 157 for the landing page 115 are redirected to a custom fallback page 119 for that program or asset. Custom fallback pages 119 set for each asset can redirect visitors 151 to more appropriate web pages 159 than a default redirect for an entire program or website (350).

However, if the expiration time for the asset has not been reached or the asset is not set to expire, the web server 120 serves the program asset to the visitor 151 (360).

User Interface Examples

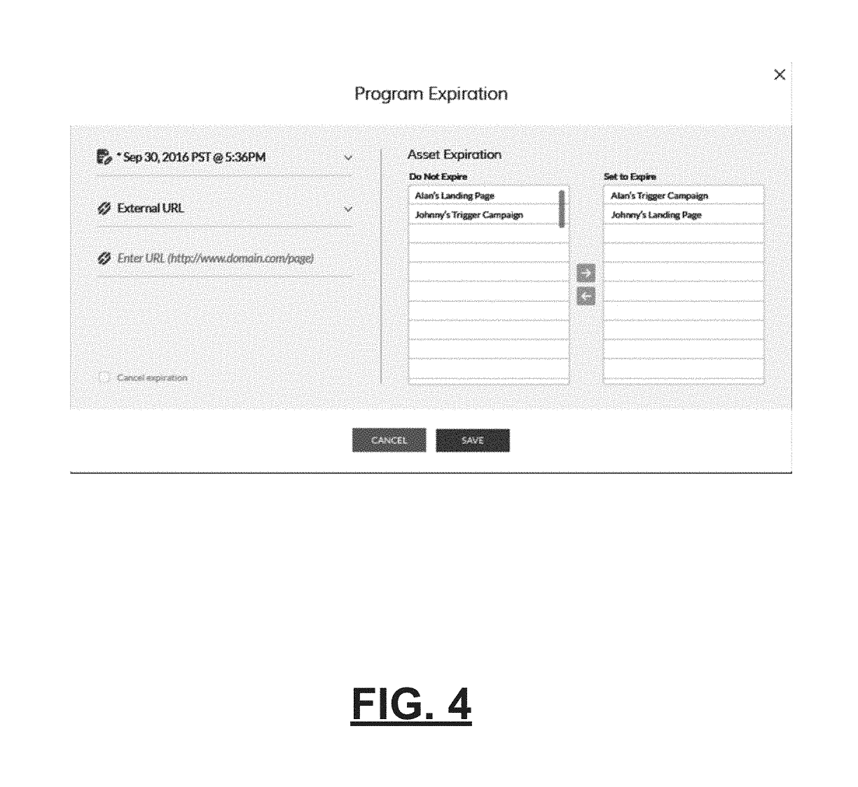

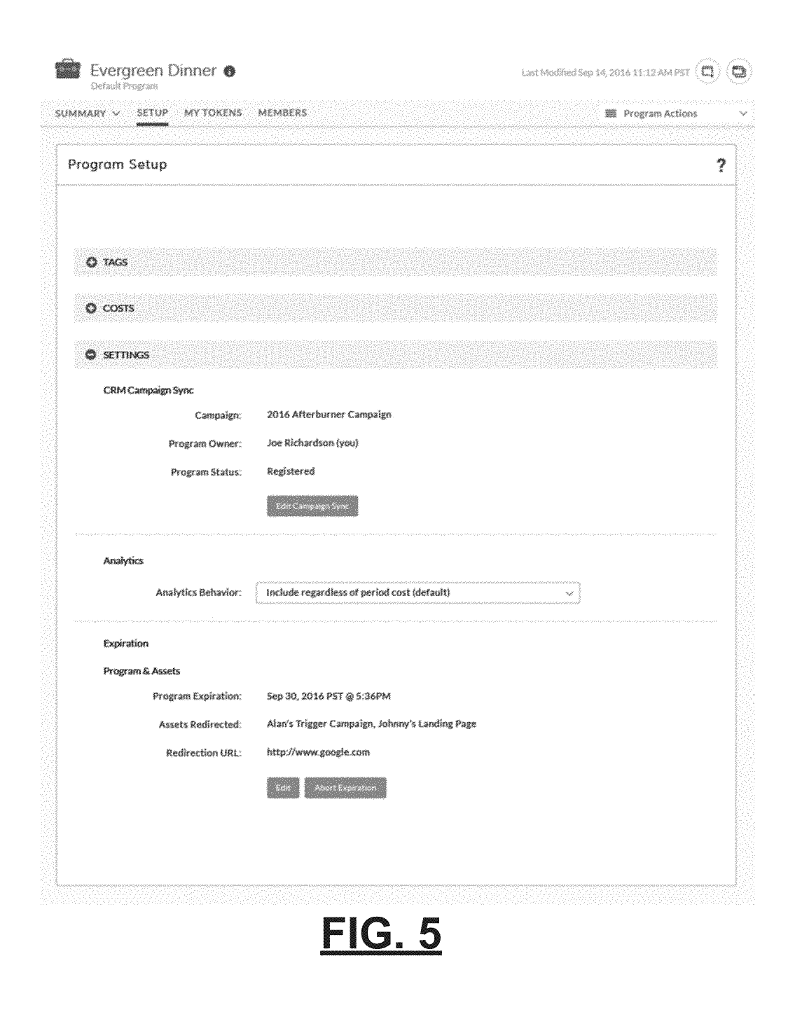

FIG. 4 illustrates a sample interface for scheduling expiration of program assets, in accordance with some aspects. FIG. 5 illustrates a sample interface for managing a program, in accordance with some aspects. With reference to FIG. 1, the sample interface in FIG. 4 is an example of a program asset expiration interface 145, and the sample interface in FIG. 5 is an example of a program management interface 140.

FIG. 4 illustrates a program expiration interface that allows program organizers and administrators to selectively set expiration times and fallback pages for program assets. As illustrated, a program organizer can select a date and time using a calendar interface for when the selected assets will be deactivated. Underneath the date and time selection, the program organizer can set a fallback page that a web server will redirect visitors to if they try to access expired program assets. In some aspects, the program expiration interface can provide saved options for the fallback page, including a default page for the subscription, a standard landing page, or a landing page from another marketing campaign. The program organizer can also input an external URL to the fallback page.

On the right side of the sample interface, the automation management system 110 lists the assets for the selected program and enables the program organizer to select which of the assets should be set to expire. For example, as illustrated, Alan's Trigger Campaign and Johnny's Landing Page are set to expire at 5:36 PM on Sep. 30, 2016, whereas Alan's Landing Page and Johnny's Trigger Campaign do not expire.

Although the example illustrated provides for only a single time and fallback page for the assets, alternate program expiration interfaces can enable program organizers to set separate expiration times and fallback pages on a per-asset basis.

FIG. 5 illustrates a sample program management interface for setting up a default-type program named Evergreen Dinner. The settings section of the example program provides information on the program such as its associated CRM campaign, program owner, and program status along with options to modify this information. The settings section also shows that Alan's Trigger Campaign and Johnny's Landing Page are scheduled to expire and redirect visitors to those assets to an external site. The program management interface further provides options for a program organizer to edit these settings or cancel the expiration. In other examples, if no assets are scheduled to expire, the interface displays a button to launch the program expiration interface.

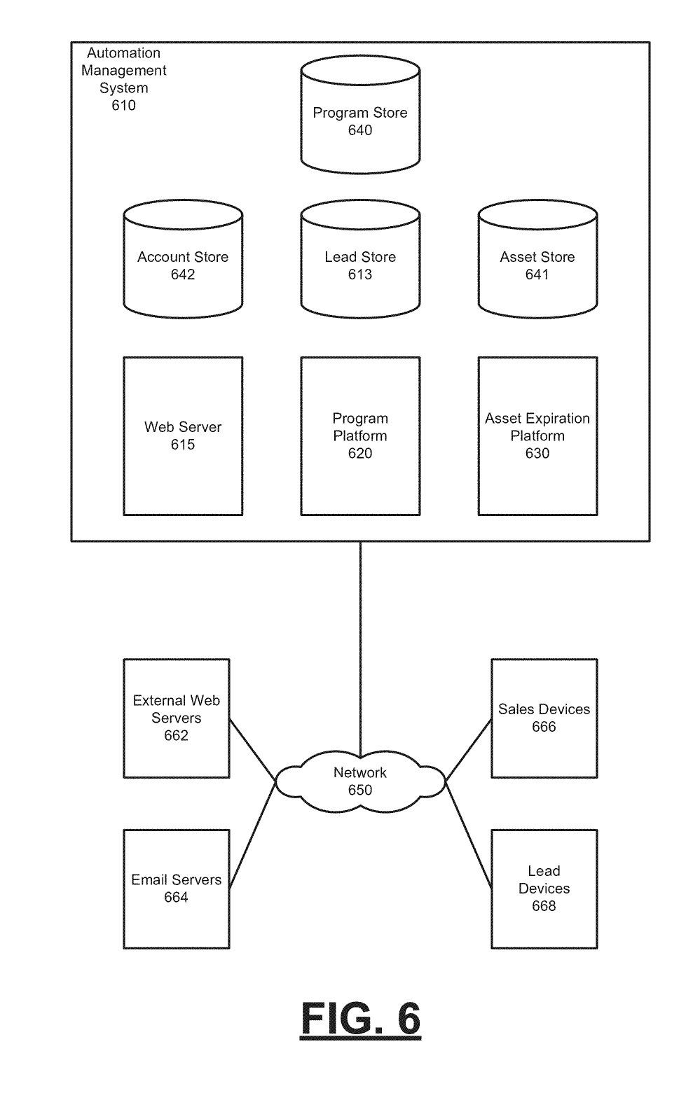

FIG. 6 illustrates example computer systems for an automation management system 610 in communication with other networked systems such as external web servers 662, email servers 664, marketer devices 666, and lead mobile devices 668.

User devices, including marketer devices 666 and lead mobile devices 668, comprise one or more computing devices that can receive user input and can transmit and receive data via the network 650. In one aspect, a user device is a conventional computer system executing, for example, a Microsoft Windows-compatible operating system (OS), Apple OS X, and/or a Linux distribution. In another aspect, the user device can be a device having computer functionality, such as a personal digital assistant (PDA), mobile telephone, smart-phone, etc. The user device is configured to communicate via network 650. The user device can execute an application, for example, a browser application that allows a user of the user device to interact with the automation management system 610. In another aspect, the user device interacts with the automation management system 610 through an application programming interface (API) that runs on the native operating system of the user device, such as iOS and ANDROID.

In one aspect, the network 650 uses standard communications technologies and protocols. Thus, the network 650 can include links using technologies such as Ethernet, 802.11, worldwide interoperability for microwave access (WiMAX), 3G, 4G, CDMA, digital subscriber line (DSL), etc. Similarly, the networking protocols used on the network 650 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 650 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

The web server 615 links the automation management system 610 via the network 650 to one or more user devices; the web server 615 serves web pages, as well as other web-related content, such as Java, Flash, XML, and so forth. The web server 615 may provide the functionality of receiving and routing messages between the automation management system 610 and the user devices, for example, instant messages, queued messages (e.g., email), text and SMS (short message service) messages, or messages sent using any other suitable messaging technique. The user can send a request to the web server 615 to upload information, for example, images or videos that are stored in an asset store 641. In addition, the user can enter marketing program data into the automation management system 610 through the web server 615 to be stored in a program store 640. Asset store 641, program store 640, and other stores can be implemented as one or more relational databases, collections of structured files such as XML files, flat plain text files, or any other method of data storage. In some aspects, automation management system 610 is a software as a service (SaaS) platform that users access through the web server 615. Additionally, the web server 615 may provide API functionality to send data directly to native user device operating systems, including iOS, Android, webOS, and Windows, among others.

A program platform 620 implements functionality to receive and store information and configuration settings for marketing programs. In addition, the program platform 620 can listen for events generated from web server 615 and execute program scripts associated with smart campaigns.

In one aspect, information may be manually inputted into the automation management system 610 through a user interface. In another aspect, information about marketing activities may be gathered by the automation management system 610 through application programming interface (API) calls to external web servers 662. In a further aspect, the automation management system 610 can use a SOAP (Simple Object Access Protocol) or REST (REpresentation State Transfer) API to receive the information. In a further aspect, web pages served by external web servers 662 can include programming (e.g., javascript code embedded in the HTML) that transmits the information back to the automation management system 610. Email servers 664 can be configured to transmit information about lead interactions with email messages back to the automation management system 610. Lead details and relevant data and metadata regarding the leads are stored in a lead store 613 with the automation management system 610.

In some aspects, the asset expiration platform 630 provides a user interface to users of the automation management system 610 for manually adding, deleting, and editing program asset expiration settings. The asset expiration platform 630 user interface receives user input corresponding to a request to set an expiration time for one or more assets from a plurality of program assets in a marketing campaign. The request can also include a redirect page. Upon determining that the expiration time has been reached, the asset expiration platform can configure the web server 615 that serves the plurality of program assets to redirect requests for the one or more assets to the redirect page.

Computer System

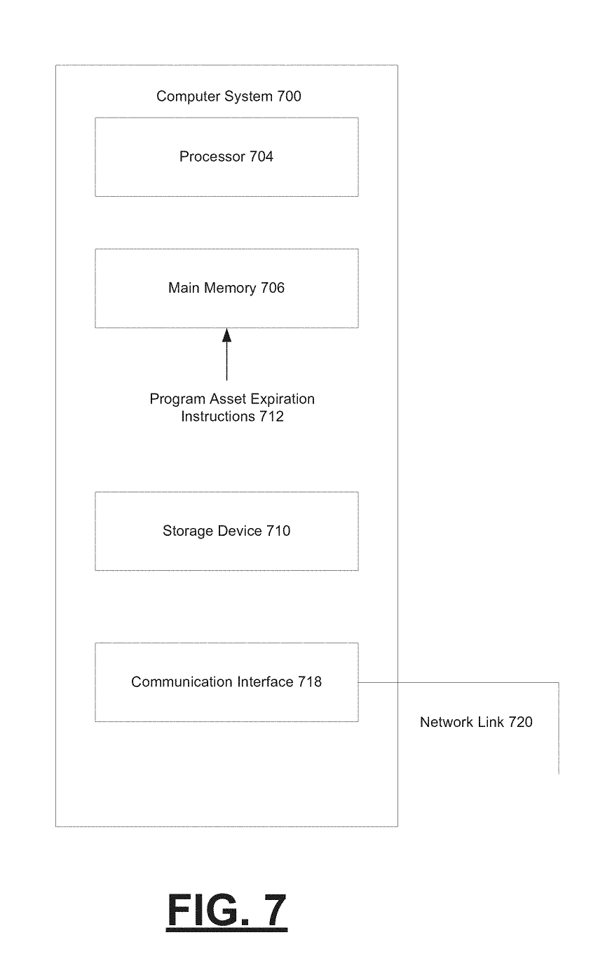

FIG. 7 is a block diagram that illustrates a computer system upon which aspects described herein may be implemented. For example, in the context of FIG. 1, automation management system 110 may be implemented using one or more servers such as described by FIG. 7.

In an aspect, computer system 700 includes processor 704, memory 706 (including non-transitory memory), storage device 710, and communication interface 718. Computer system 700 includes at least one processor 704 for processing information. Computer system 700 also includes the main memory 706, such as a random access memory (RAM) or other dynamic storage device, for storing information and instructions to be executed by processor 704. Main memory 706 also may be used for storing temporary variables or other intermediate information during execution of instructions to be executed by processor 704. Computer system 700 may also include a read only memory (ROM) or other static storage device for storing static information and instructions for processor 704. The storage device 710, such as a magnetic disk or optical disk, is provided for storing information and instructions such as program asset expiration instructions 712. The communication interface 718 may enable the computer system 700 to communicate with one or more networks through use of the network link 720 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Examples described herein are related to the use of computer system 700 for implementing the techniques described herein. According to one aspect, those techniques are performed by computer system 700 in response to processor 704 executing one or more sequences of one or more instructions contained in main memory 706. Such instructions (e.g., program asset expiration instructions 712) may be read into main memory 706 from another machine-readable medium, such as storage device 710. Execution of the sequences of instructions contained in main memory 706 causes processor 704 to perform the process steps described herein. In alternative aspects, hard-wired circuitry may be used in place of or in combination with software instructions to implement aspects described herein. Thus, aspects described are not limited to any specific combination of hardware circuitry and software.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A program asset expiration system comprising:
a memory resource to store instructions; and
one or more processors using the instructions stored in the memory resource to perform operations including:
receiving user input corresponding to a request to set an expiration time for one or more assets from a plurality of program assets associated with a program, the request including a redirect page; and
upon determining that the expiration time has been reached, configuring a web server that serves the plurality of program assets to redirect requests for the one or more assets to the redirect page,
wherein requests for program assets that are not among the one or more assets set to expire are not redirected to the redirect page.

2. The program asset expiration system of claim 1, wherein the memory resource stores further instructions to perform operations including:
receiving a request at the web server for an expired asset of the one or more assets from a web browser of a visitor; and
transmitting a data message corresponding to the redirect page from the web server to the web browser of the visitor.

3. The program asset expiration system of claim 1, wherein the memory resource stores further instructions to perform operations including:
configuring the web server to redirect requests to a first asset of the one or more assets to a first redirect page; and
configuring the web server to redirect requests to a second asset of the one or more assets to a second redirect page.

4. The program asset expiration system of claim 1, wherein the one or more assets include a landing page and the program is a marketing campaign.

5. The program asset expiration system of claim 4, wherein the one or more assets include a program script associated with the marketing campaign.

6. The program asset expiration system of claim 5, wherein the memory resource stores further instructions to perform operations including:
deregistering one or more listeners for the program script associated with the marketing campaign.

7. The program asset expiration system of claim 1, wherein each of the one or more assets has a separate expiration time.

8. A method of program asset expiration, the method being implemented by one or more processors and comprising:
receiving user input corresponding to a request to set an expiration time for one or more assets from a plurality of program assets associated with a program, the request including a redirect page; and
upon determining that the expiration time has been reached, configuring a web server that serves the plurality of program assets to redirect requests for the one or more assets to the redirect page,
wherein requests for program assets that are not among the one or more assets set to expire are not redirected to the redirect page.

9. The method of claim 8, further comprising:
receiving a request at the web server for an expired asset of the one or more assets from a web browser of a visitor; and
transmitting a data message corresponding to the redirect page from the web server to the web browser of the visitor.

10. The method of claim 8, further comprising:
configuring the web server to redirect requests to a first asset of the one or more assets to a first redirect page; and
configuring the web server to redirect requests to a second asset of the one or more assets to a second redirect page.

11. The method of claim 8, wherein the one or more assets include a landing page and the program is a marketing campaign.

12. The method of claim 11, wherein the one or more assets include a program script associated with the marketing campaign.

13. The method of claim 12, further comprising:
deregistering one or more listeners for the program script associated with the marketing campaign.

14. The method of claim 8, wherein each of the one or more assets has a separate expiration time.

15. A non-transitory computer-readable medium that stores instructions, executable by one or more processors, to cause the one or more processors to perform operations that comprise:
receiving user input corresponding to a request to set an expiration time for one or more assets from a plurality of program assets associated with a program, the request including a redirect page; and
upon determining that the expiration time has been reached, configuring a web server that serves the plurality of program assets to redirect requests for the one or more assets to the redirect page,
wherein requests for program assets that are not among the one or more assets set to expire are not redirected to the redirect page.

16. The non-transitory computer-readable medium of claim 15, storing further instructions to perform operations including:
receiving a request at the web server for an expired asset of the one or more assets from a web browser of a visitor; and
transmitting a data message corresponding to the redirect page from the web server to the web browser of the visitor.

17. The non-transitory computer-readable medium of claim 15, storing further instructions to perform operations including:
configuring the web server to redirect requests to a first asset of the one or more assets to a first redirect page; and
configuring the web server to redirect requests to a second asset of the one or more assets to a second redirect page.

18. The non-transitory computer-readable medium of claim 15, wherein the one or more assets include a landing page and the program is a marketing campaign.

19. The non-transitory computer-readable medium of claim 18, wherein the one or more assets include a program script associated with the marketing campaign.

20. The non-transitory computer-readable medium of claim 19, storing further instructions to perform operations including:
deregistering one or more listeners for the program script associated with the marketing campaign.
